(19) United States
(12) Patent Application Publication
(10) Pub. No.: US 2006/0195408 A1
(43) Pub. Date: Aug. 31, 2006

(54) Method and apparatus to enhance cognitive functioning and its manifestation into physical form and translation into useful information

(76) Inventor: Todd L. Siler, Aurora, CO (US)

Correspondence Address: Gibson, Dunn & Crutcher LLP, Suite 4200, 1801 California St., Denver, CO, 80202, US

(21) Appl. No.: 11/334,842

(22) Filed: Jan. 19, 2006

Related U.S. Application Data
(63) Continuation of application No. 09/882,921, filed on Jun. 15, 2001, now abandoned.
Application No. 09/882,921 is a continuation-in-part of application No. 09/164,285, filed on Oct. 1, 1998, now abandoned.
Application No. 09/164,285 is a continuation of application No. 08/889,475, filed on Jul. 8, 1997, now abandoned.
(60) Provisional application No. 60/021,498, filed on Jul. 10, 1996.

(51) Int. Cl. G06F 15/18

(52) U.S. Cl. 706/16

(57) ABSTRACT

The present invention provides a method and apparatus for enhancing cognitive functioning and its manifestation into physical form and translation into useful information for improving functioning in human experience, for example, business, academic or personal endeavors.

### FIELD OF THE INVENTION

The present invention relates to the field of cognitive functioning and results thereof, particularly problem solving, inventing, innovating and realizing human potential.

### BACKGROUND OF THE INVENTION

The present invention relates to methods and apparatuses for facilitating cognitive functioning and the results of such functioning as evidenced by physical form. Such facilitation includes interpreting, analyzing and applying the insights and discoveries that emerge from the guided exploration and analysis of the physical symbolic forms. These physical forms can be created individually or collaboratively and can also be represented and enhanced by virtual reality or electronically with the aid of computer technology to stimulate the human sensorium. Such physical forms are tangible, visual, symbolic and metaphorical information for problem solving, inventing and other functions requiring creative and critical mental functioning.

In the mid-1900's in the United States, business, educational and political leaders recognized the need for gathering intellectuals from various fields in order to creatively generate new ideas for rational consensus so as to accelerate and enhance the decision making process. These sometimes well-funded collaborative efforts came to be known by the coined words “think tank” or “task force.” Recognizing that “a picture is worth a thousand words” at times, graphic presentations, slide shows and pictures were often used. These tools accelerated decision making as well as provided motivation and emotional stimulation to discussions. The advertising industry has repeatedly demonstrated that pictures evoke emotional responses. These emotional responses can motivate people to buy products, or adopt a particular opinion. Pictures can immediately provide a context for thoughts and thereby clarify the thoughts being presented.

The preferred models of the present invention incorporate not only the visual impact of 2-D pictures but are five-dimensional (“5-D”). 5-D models embody commonly accepted 3-dimensional physical space, as well as 4-D perspective. 4-D perspective involves time and motion. The “fifth dimension” relates to all forms of symbolism, or symbolic languages (e.g., words, images, objects, signs, stories, symbols, archetypes, for example). The 5-D models can be kinetic, multi-layered and often highly animated objects.

The methods and apparatuses of the present invention facilitate business, educational, community and family functions by giving visual, tangible and concrete form to people's creative and critical ideas. The present invention provides tools for visualization to foster the exploration of ideas and the communication of these ideas to others through natural, hands-on methods. The methods of the present invention illuminate thought processes through unique modeling methods.

The present invention may be used to stimulate creativity, to discover and make inventions, to connect things that seem unrelated, to solve problems and find solutions, to examine and question original ideas, and to enrich the experience of learning and enhance communication.

Although the inventor is not aware of any other similar inventions, there are other representative patents in the field. For example, U.S. Pat. No. 4,717,343 relates to a method of conditioning a person's unconscious mind to affect a change in the person's behavior by using a program of video pictures to condition the person's thought pattern to alter behavior.

U.S. Pat. No. 4,734,038 relates to a system and method of psycho-actualized learning comprising (1) selecting a behavior to be modified, (2) defining the steps to be taken to effectuate the modification, (3) assigning a mnemonic for each step and (4) providing a visual image of a role model for behavioral emulation.

U.S. Pat. No. 5,151,080 relates to a method and apparatus for inducing and establishing a changed state of consciousness by using electro-acoustic means for creating and generating electromagnetic sound signals, producing synthetic human speech signals, superimposing the sound and speech signals to make a superimposed signal, and conveying the signal to the ears.

U.S. Pat. No. 5,312,114 relates to a method and apparatus for enhancing decision making comprising (1) thinking about a subject until an issue related to the subject comes to mind and making a choice from alternatives of the issue, (2) looking inside the head to ask if you are right, (3) picturing the subject in the head and while daydreaming the picture, listening for thoughts on both sides of the issue and change over time and (4) verbalizing conclusions.

U.S. Pat. No. 5,387,104 relates to an instructional system for improving communication skills using computer technology to integrate multi-sensory stimuli for synthesis of individualized instruction, evaluation, and prescription for advancing such skills.

These patents disclose methods and systems which, when used in combination, lead users to improve their visualization skills, creativity, communication and decision making abilities. In contrast, the present invention focuses on using a detailed model, preferably a symbolic 5-D model, to improve functions, including solving problems and conceptualizing ideas in a visual and tangible way. Also, 5-D models make the subconscious mind conscious and comprehensible. Furthermore, they reveal a person's understanding of a subject, viewpoint or field of knowledge. Through use of this model in the instant process, the user can quickly grasp and convey a concept or experience, regardless of how complex the concept is or how personal and subtle the experience.

The process of the present invention differs from these prior disclosures in that, in addition to providing prepared materials for the user to work with, it carefully instructs the users in creating their own materials and in constructing a symbolic multi-dimensional physical model. Moreover, it guides users in discovering and adapting materials from their immediate environment, demonstrating how to make comparisons between different subjects, including: analogy, figure of speech, metaphor, symbol, story, allegory, pun, story-writing, story-telling, scenario-making, visualizing, hypothesizing, brainstorming, role-playing, and many more. The instant process not only makes metaphors to connect one thing to other things, it also uses all the ways of analyzing, evaluating, modeling, and tangibly realizing the meanings of the connections made.

### SUMMARY OF THE INVENTION

One of the methods of the present invention is called “metaphorming.” As used herein “metaphorming” refers to the act of making connections, discoveries, inventions and applications. It involves combining, integrating, bridging, and relating many different sources of information and material forms. To metaphorm is to connect, shape, and transform some thing in our mind's eyes and hands. The term is derived from the ancient Greek words meta which means “between,” “after,” “beyond,” “transcending,” and phora which means “transference.” Metaphorming is a four step process described in more detail below.

It is an object of the present invention to provide a method for improving communication. The act of getting people to truly communicate is fundamental to their sense of success, happiness, mental health, and well-being. The experiential nature of the methods and apparatuses of the present invention connects people with themselves and with others in profound way, thus enriching communication.

It is a further object of the present invention to provide a method for leveraging tacit and explicit knowledge. People know more than they think they know. The methods and apparatuses of the present invention help extract this knowledge in a natural, intuitive, easy and pleasurable way, leaving people the option of working individually or collaboratively to this end.

It is a further object of the present invention to provide a method for tapping human potential. The methods and apparatuses of the present invention enable people to see the limits or boundaries of their knowledge, and suggest ways of transcending them. This is particularly useful when organizations (such as companies and schools) need to rapidly and thoroughly assess an individual's knowledge, core competencies, skills, and resources.

It is a still further object of the present invention to provide a method for fostering creativity, breakthroughs and innovations. The methods and apparatuses of the present invention catalyze and initiate connection-making and idea-generation. They produce fresh insights, cultivate discoveries, inventions and innovations with multiple applications.

The present invention can be applied to a number of functions in the following representative areas and to the overall integration of these areas of peoples' lives:

In the corporate setting, it can be used, for example, to (1) enrich and accelerate research, development and design processes; (2) create multi-purpose visual knowledge maps; (3) give form to global strategic plans and corporate mission statements; (4) enhance re-engineering processes and effectively implement tactical and practical action plans; (5) improve communication, team building skills, collaborative work, innovation and productivity; (6) make connections between different work processes, ensuring best practices; (7) to conceptualize a problem or scientific paradigm in order to test a hypothesis or challenge an assumption, or examine and rethink the implications of a theory; and (8) for crisis management and conflict resolution. The process of the present invention is effective in enhancing functions in the corporate realm, for example, as an “emergency procedure,” or crisis management, in opening up the imagination of people whose creativity is severely blocked by anxiety, fear, close-mindedness or compartmentalization.

In the educational setting, it can be used, for example, to (1) make improvements in learning and applying curricular (content) materials; (2) better understand and use curricular materials applied to everyday life; (3) design educational games that enhance the learning process; and (4) facilitate advanced planning and development of scholastic activities.

The present invention also is useful in the family and home, for example, to (1) foster communication between family members; (2) develop abilities of families to act as lifelong collaborative learners; (3) improve family functionality, cohesion and well-being; (4) nurture family values, awareness and interest in learning, and (5) discover points of human commonalities.

Concretely, the work done through the process of the invention can include areas as disparate as the design of an innovative museum and garden; the re-engineering of aspects of a telephone company's installation and service system; the development of new technology and services for leading Application Service Providers (ASPs) in the Internet industry; the invention and development of an alternative plasma fusion energy system; the enhancement of learning systems for schools; and the improvement of systems and techniques for dealing with children-at-risk and broken families, among other familial and social dysfunctions.

The process of the present invention also may be used to enhance other functions, including to design games, children's pop-up books, CD-ROM's, Internet electronic games and services, audiocassettes, videotapes and practical workshop exercises in which the process serves as the basis of their operations. A version of the process comprising the 5-D model in a wheel form may be used in educational and corporate settings, for example, to solve a particular problem of a company. The process of the present invention can be adapted to a variety of media, both traditional and electronic.

The process can be used by an individual or by large groups of many hundreds of people, or more simultaneously. The users can be from all levels of education, social, economic and ethnic backgrounds and ages.

### DESCRIPTION OF THE FIGURES

FIG. 1 sets forth the four steps of the process of the present invention.

FIGS. 2 through 7 show various forms of 5-D models useful in the present invention applications.

FIGS. 8 through 13 show the evolution of a 5-D model described in the Example

### DETAILED DESCRIPTION OF THE PREFERRED EMBODIMENTS

The preferred physical, symbolic models (i.e., apparatuses) are five-dimensional (“5-D”). 5-D models embody commonly accepted 3-dimensional physical space, as well as 4-D perspective. 4-D perspective involves time and motion. The “fifth dimension” relates to all forms of symbolism, or symbolic languages (e.g., words, images, objects, signs, symbols, numbers, figures of speech, euphemisms, puns, riddles, stories, visual metaphors, physical analogies, allegories, archetypes, etc.).

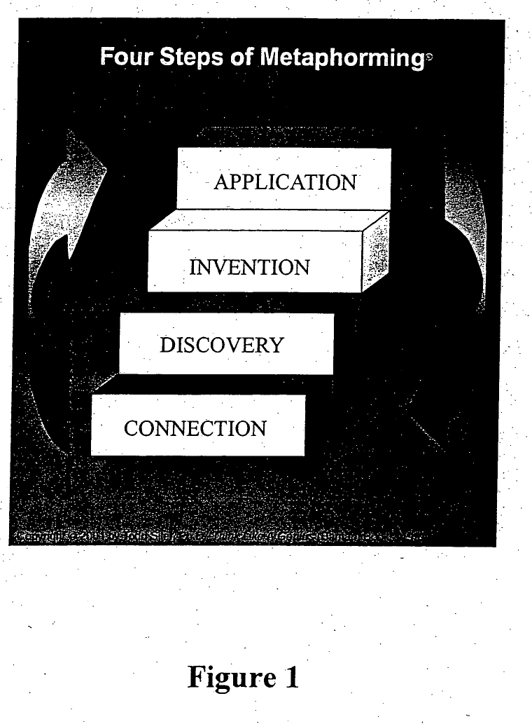

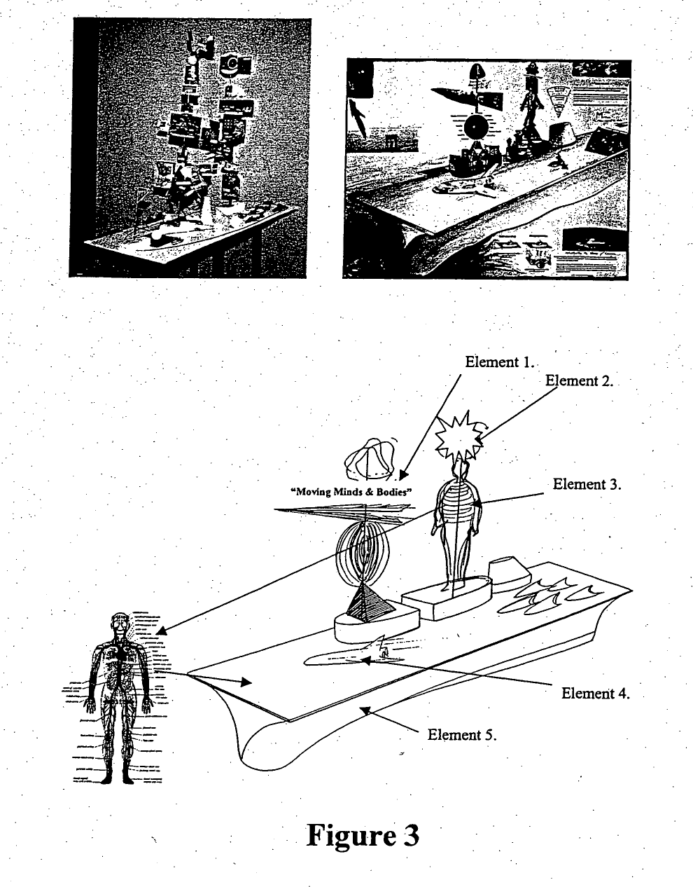

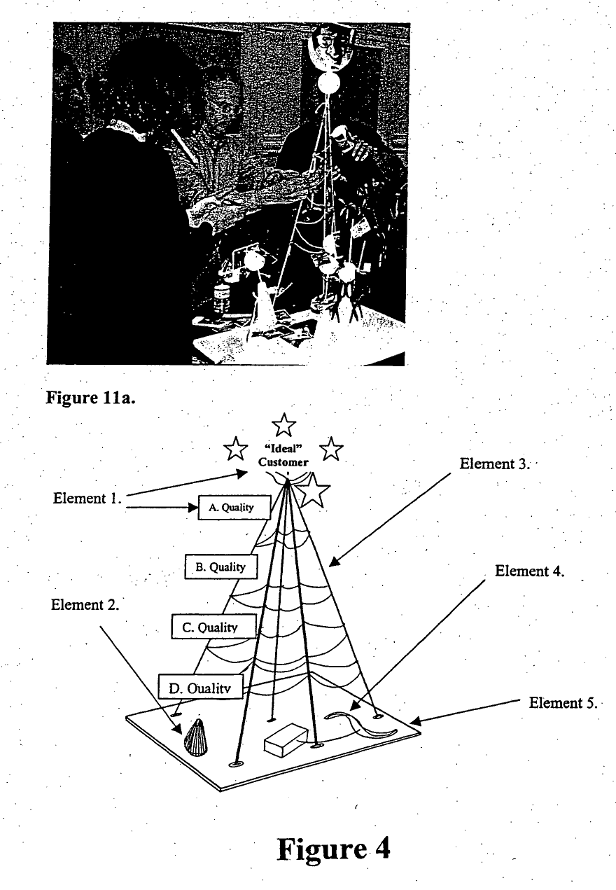

Referring to FIGS. 2 through 6, 1-Dimension refers to all forms and usages of words (Element 1). Dimensions refer to all forms and usages of images and pictures (Element 2). 3-Dimensions refer to objects and structures (Element 3). 4-Dimensions refer to all forms and usages of moving, dynamic parts or structures (Element 4). And, 5-Dimensions refer to the whole spectrum of symbolic creations: from abstract to concrete things; from figurative to literal things; from non-objective, or imaginary, to representational or realistic things (Element 5). In short, 5-D symbolic models can be described as the arts. “The arts embody the languages of our senses of touch, taste, smell, hearing, seeing and knowing. Without these languages we couldn't begin to describe or relate our experiences of life in any meaningful way.” (Voice, March 2001, p. 13; published by the Washington Alliance for Arts Education, Seattle, Wash.)

When all five dimensions of communication are used to generate, articulate and convey viewpoints, ideas, insights, and inventions or innovations, the sense of understanding increases, as does the meaning and usefulness of the information being communicated. As well, the information is retained longer and applied in more personally meaningful and productive ways. Furthermore, when the methods and apparatuses of the present invention are experienced, connections between different sources and forms of information become apparent. Knowledge and ideas that previously remained separate and unrelated to one another become connected. In effect, the tools of the present invention enable the user to see the deeper connections and relationships between all forms of information. This act of seeing and creation improves human communication, strengthens and inspires collaborative learning, helps people leverage their tacit and explicit knowledge, and accelerates breakthroughs and innovations.

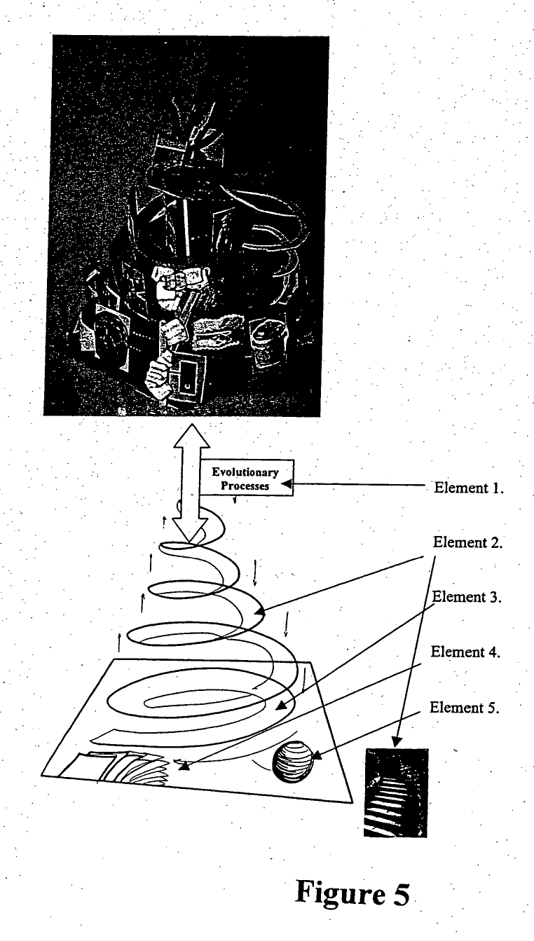

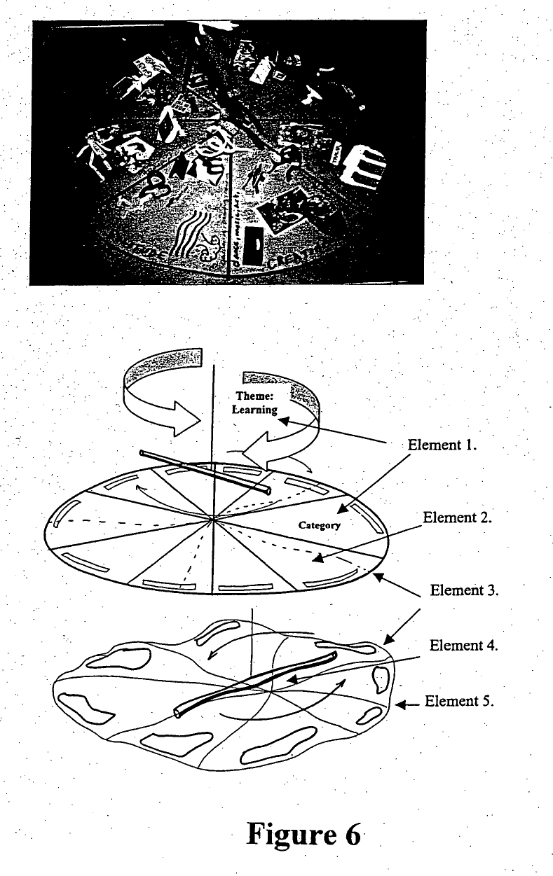

The 5-D models can be kinetic, multi-layered, highly animated and dynamic objects, which makes them literally and figuratively moving, so to speak, in more ways than one; meaning, their demonstrative and communicative powers can be especially visceral and emotionally moving. This is shown in FIGS. 5 and 6.

The methods and apparatuses of the present invention facilitate business, educational, and family functions by giving visual, tangible and concrete form to creative and critical thinking and ideas—thus making it easier and more effective to communicate thoughts, feelings, viewpoints, beliefs, realizations, intuitions and ideas.

The physical symbolic models of the present invention can be created spontaneously and intuitively, or logically and methodically. They can be “unpacked” (analyzed and interpreted) and discussed in an orderly, rational, and systematic way or randomly.

Furthermore, unlike the conventional use of multi-media, in which words, images, objects, and other forms of language are used to enrich the experience of information or ideas presented, the symbolic nature of these 5-D models allows the users to continually transform the model's content, physical attributes, meanings, implications, associations, usages and purposes.

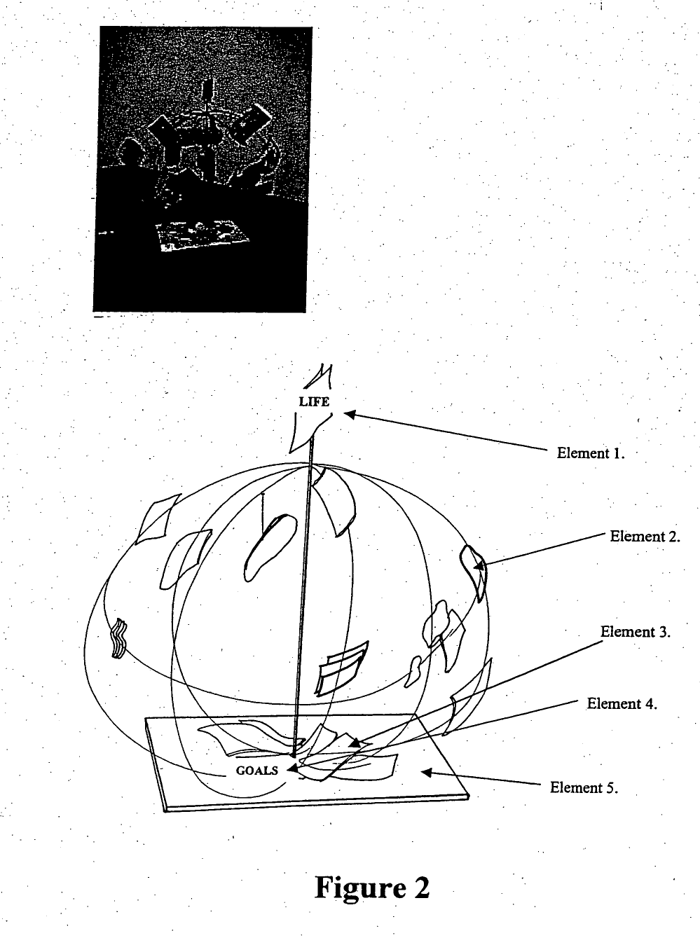

The 5-D models and model-building activity deepen people's understanding and knowledge of subject matter, topics, issues, ideas, feelings, viewpoints, beliefs, values, and their implications. Every mark or symbol or movement in these physical models is symbolic and can be understood as representing visible, tangible thoughts and concepts. See FIGS. 2 through 6. Each symbolic element reveals a world of hidden information and sensibilities in the form of Elements 1 through 5, discussed above. This versatile symbolic language can be effectively used to tell stories, relate data, information and knowledge in such a way that it transcends our compartmentalized, disciplines and knowledge. The 5-D symbolic models of the present invention provide innumerable clues for solving problems, reframing and answering questions, or developing an opportunity.

As users interpret the meaning of the models, a web of connections is created in the human brain that involve visual, auditory, tactile and other sensory modalities which serve to reinforce this content and store it long-term memory. Contemporary brain research on memory and learning suggest that this phenomenon of encoding information and sensory stimuli according to its emotional significance and existing knowledge structures underlies the operations of memory. (Newsweek, Jun. 15, 1998, p. 48-53; “How Memory Works”). This neurophysiological phenomenon is referred to as elaborative encoding. The processes of the present invention can be the biological basis or manifestations of elaborative encoding.

The 5-D models can be connected with one another through multiple interpretations. When users and others add their impressions, insights grow and mutual understanding increases. This shared understanding is essential for ensuring that individuals are aligned in the implementation and execution of their common goals and specific tasks.

The present invention provides tools for conceptualization, visualization and expressive manipulation. These tools may be used to foster the generation, exploration, implementation, advertising, marketing, and selling of ideas and knowledge, and the communication of these ideas to others through hands-on, interactive methods that can involve or be augmented by media technology. The methods of the present invention illuminate thought processes and all forms of “physical thinking” through unique modeling methods—thus providing a means of expressing this knowledge in myriad ways. The methods of the present invention draw upon the user's innate ability to build and construct things, without requiring any learned skill or artistic ability to engage this activity.

Metaphorming taps people's tacit and explicit knowledge, while revealing their many faceted intelligence (visual, spatial, mathematical/logical, musical, kinesthetic, emotional, intrapersonal, and interpersonal)—allowing for a greater freedom of conceptualizing, representing, and expressing ideas, viewpoints, beliefs, vision, values, issues, problems or opportunities The metaphorming methods and apparatuses enable people to apply their innate ability to think differently and innovatively—inspiring a sense of creative freedom, freeing the mind, encouraging openness, and exercising people's curiosity, skepticism and wonderment.

The present invention has been proven to stimulate creativity, breakthroughs and innovations in corporations, businesses, schools, communities, families and individuals. It has been used to make tangible discoveries and inventions by physically and conceptually connecting various types and forms of information, knowledge, ideas and things in highly original ways.

The process of the present invention, metaphorming, is set forth below:

The invention comprises a system comprising an iterative process comprised of four tangible steps (1) connection, (2) discovery, (3) invention, and (4) application.

Before these steps can take place, however, the user must select a function to be enhanced or propose a focal question to explore a specific subject, topic, issue, problem or opportunity. Once the question or function to be enhanced has been selected, a model is constructed. Users create images and forms or structures from an array of materials and techniques (i.e., marking pens, paints, magazines, photographs, collage elements, drawings, tape, etc.) delivered and used either physically or by electronic means via media technology.

Allow the model to develop and evolve at the users preferred, natural pace, or set a time limit, and recommend that the 5-D model be constructed within this time frame. Instructor or facilitator can emphasize the importance of modifying and changing the model.

The models may be in the form of drawings, three dimensional constructions or other forms of expression, including four dimensional animation, which involves time and motion in kinetic models. The depictions may use all systems of comparison and connection-making (including, for example, metaphor, analogy, figure of speech, story, symbol, hypothesis, and pun) in order to make connections between seemingly unrelated things, ideas, events and experiences.

Simple models created during the process normally take between 30 minutes and 3 hours to complete. More complex models, or models which depict complex connections, may take substantially more time.

Users of the process of the present invention create visual models by depicting metaphorms (which are a combination of metaphors, analogies, symbols, and stories) and connections between the function they wish to enhance and other things, either natural or human-made.

Once the model is constructed, the metaphorming process can begin. The steps are as follows:

1. Connecting

Initially, users should address the physical characteristics and qualities of their models before addressing the conceptual elements and intentions. Questions can assist users in this process. The questions help orient and prepare the user's mind for the deeper journey into their creative processes and creations. Such questions may include, but are not limited to, the following: (1) What do you see? (2) What does your model look like? (3) Why did you give it this shape or form? (4) What are other visual elements that made up the model? (5) Are there a lot of colors used in the models, and what do they mean with respect to their forms and shapes? (6) Describe some of the model textures: Are they flat or very dimensional with much texture? (7) Are the shapes, forms and media used in the models similar? (8) Are the icons and symbols used representational, figurative or abstract? The questions to be asked will vary accordingly to meet the necessary requirements of the particular situation.

After noting the physical characteristics and qualities, users should address the conceptual elements and intentions. They should describe the music or sounds the symbols and icons evoke, asking, for example, these kinds of questions: (1) What does a particular symbol mean? (2) What symbols do you see in real life that represents other things? Are they concrete or abstract? (3) What would these works sound like, if they had a sound (e.g., classical, rock, jazz, rap, new age, and tribal)? (4) How would these works be different if they were the size of a room and participants could walk into or through them? (5) How would these works be different if they were four-dimensional, i.e., had a time element to them, like moving kinetic sculptures? (6) How would your model be different if it were the size of a room or building? (7) How would your experience of the model be different? During the connection step, users should list as many insights as possible.

2. Discovering

Users further explore the connections and insights made in Step One. This discovery or “exploring” step may involve a number of activities including research, remodeling and additional unpacking.

Users should research elements of the connections and insights made in Step One. This research can involve use of a variety of tools, including, for example, the library, Internet, observations, interviews and direct contact with experts in a particular field, personal knowledge and interests, and other artistic and scientific resources. Users should get to know as much about their previous connections as feasible. Research should be guided towards identifying relationships between forms and processes, and between like and unlike processes, and exploring interconnections between the whole of systems and their parts. Exploration also involves comparing categories of relationships in and among things that seem unconnected or unrelated. For example, with regard to management information systems, users could explore power plants, overnight package companies, or learn more about how trees, nerve cells and other natural systems grow. They also should define the products of their growth. This research would help the users, in turn, to learn more about management information system designs.

Search for relationships between and within the models. Go beyond the surface of the things you see, hear, taste, smell and touch, to discover and understand the layers of details and levels of information. Relate why you selected the particular images and objects. Listen carefully and take notes on what the participants say. This will help users construct and respond to their next set of questions. Examples of such questions may include: (1) How many of you have had a similar experience to this? (2) How is this image similar to other images within the model? (3) How is one image related to the whole of the model? (4) How is each part embedded, or “nested” in the whole? (5) Does your model have a center? If so, where is it? (6) How would the meaning of the model change if another category is moved to the center? How would this modification change the message?

After thorough research, the users should amend and modify their previous models based on the findings of their research Research will often lead to additional insights and possibly “discoveries.” These insights and discoveries should be incorporated into the previously generated models or used as a guideline to amend these models. This may also include constructing models jointly among the users. Another possibility is for users to model particular aspects of the earlier models, using the research to explore areas of interest in detail.

As used herein, “unpacking,” or analyzing and interpreting, comprises the following: The first stage of unpacking involves stepping back and observing the types of icons and symbols that were employed in the model as well as the similarities between icons. A list of the users' responses is generated. The list acts as a log of responses, so that users can revisit and analyze, for example, a particular statement or figure of speech used to describe a symbol or convey an idea.

Upon completion, users analyze and interpret the models. This process is referred to as “unpacking.” Unpacking enables the users to become familiar with the full realm of symbols used to create their models. It also helps users understand the symbols in a deeper, more meaningful and productive way. This, in turn, enables users to explore and interpret both their conscious and unconscious thoughts. It creates a window into the mind of the individual engaged in the process. It sheds light on the systems, processes and problems that may have been previously obscured by any number of mental barriers or blocked by the subconscious mind. Insights into the models and functions are formed during this unpacking activity.

In the second stage of unpacking, users take turns interpreting their model creations for the other users, if present. Users should explain why they selected the symbols, colors, shapes, etc. that they did. They should also note what other creations are similar to their creations and why. Each aspect of the user's model should be explored in as great depth as possible, with all users listening closely to the expressions of language and personal stories used in the descriptions. All users are encouraged to verbally interpret and discuss the models being presented. By doing this, users gain valuable insights concerning their models (and ultimately their thought processes) that otherwise would have remained hidden.

3. Inventing

In this step, users will develop a plan and method for realizing an idea or inventing something that improves the function they wish to enhance. The inventions will be based on their exploration and discovery of the original connections. The inventions will be represented in the form of symbolic models. Again, models provide the method of visualization and conceptualization necessary to explore the inventions in a tangible manner.

Using the example of management information systems, users may invent a method for improving the system through discoveries made in researching how apple trees are like computer systems, or how apple orchards are similar in process to computer networks. The management information system may be redesigned to function more like an apple tree, or orchard, based on an understanding of the ecology of this natural system and how to sustain and maintain a healthy, ecologically sound system. The users would then express this invention in a model. The model would serve to put into visual form many of the aspects of the invention. The model would be “unpacked,” with further discoveries perhaps being made, and the invention model amended accordingly. This step encompasses recognizing and understanding the process of the symbolic model as an invention or innovation and posing other possibilities based on the connections and discoveries made. Examples of questions to ask may include: (1) What are some ideas that were generated based on previous discussion and discoveries? (2) Where is the invention or innovation in the symbolic model? (3) Describe the steps taken to make the invention, such as, gathering, assembling, modifying and combining materials and information.

4. Applying

In this step, users will develop a plan and method for applying their inventions to improving the function they wish to enhance. They will also create a list of action items necessary for the implementation of their inventions. The tactical plan and list are preferably incorporated directly into the invention model.

A single invention can stimulate and support successive generations of discoveries and inventions. The improvement to the functions generated in Step Three can also be applied to other areas. For example, inventions that benefit the management information systems function of a company may also be used to improve other areas of the company, including, for example, product design, sales, marketing or product distribution. Models also can be developed that are specific to these areas. The process of the present invention serves to extend ideas, relationships, meanings, implications and information contained in the 5-D symbolic models into real-life areas, situations, circumstances and events.

The application step also involves a second generation (and subsequent generations) of invention based on the first invention, which is rooted in the initial comparison. The instant process is, therefore, iterative in nature—like the creative process itself Exemplary questions may include: (1) How can the model be applied to understand different things experienced during the course of a day? (2) How can the model be applied to understand things taught in school? (3) How does the geometry of the model reflect the geometry of the environment?

For example, a company engaged in re-engineering its management information systems (MIS), could try connecting the MIS functions to a number of functions outside this area of specialized information. Although this information may be unlike in form, appearance or representation, it is potentially similar in process, i.e., the way it works. Since a well-functioning management information system will deliver information on demand, users could explore other delivery systems, such as electric power plants and grids (which deliver electricity), overnight package companies (which deliver parcels), or apple trees (which deliver fruit), or brain cells (which deliver neurotransmitters). The visual models would, in this instance, depict the connections between the process of management information systems and the processes of these other systems.

### EXAMPLE 1

Education

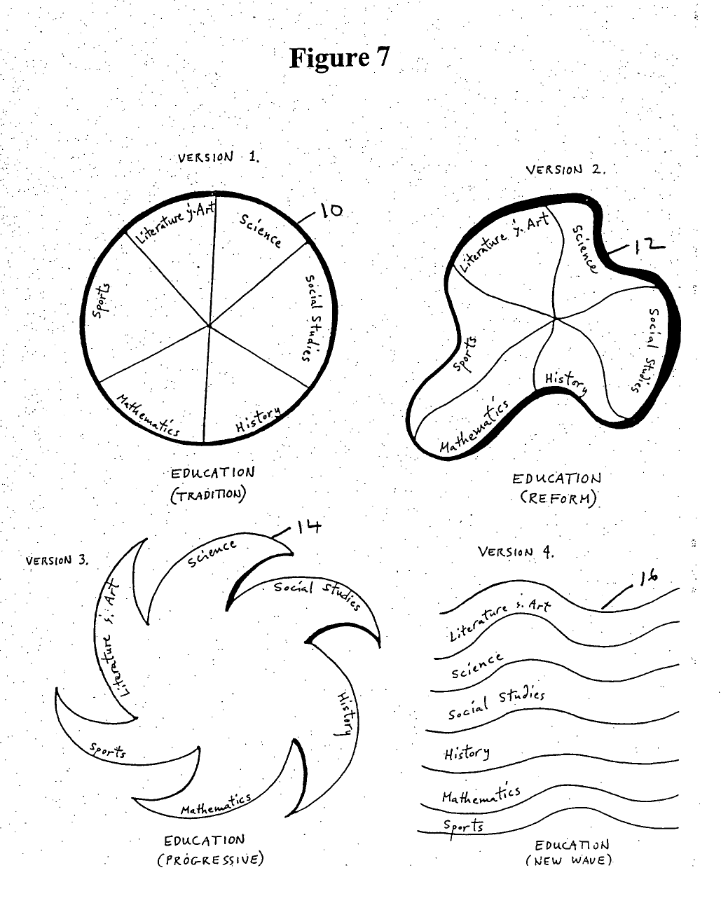

The instant process may be used in every day life to explore a certain concern, issue, problem, obstacle or opportunity. In this example, the process uses as the model, a wheel and spinner concept that is familiar to most people and is used to enhance educational functions. It can also use a variety of other shapes and forms, as seen in FIG. 7.

Referring to FIG. 7, in this example both the wheel 10 (or other forms 12, 14, 16) and the selection of its content are created by the participants using their own knowledge base and life experiences. Since the process uses the participants' life experiences, it is particularly meaningful to them and can be used for a variety of purposes. Its uses include connecting diverse sources and forms of information, combining ideas, and relating experiences and other activities. It can be used on a one-time basis to introduce and teach benchmark curricular content or it can be repeatedly used in a classroom environment over the course of a semester or longer. During the life cycle of the process, using the wheel, the participants can continually modify its design and content, making a highly personalized yet universal teaching tool.

Procedure

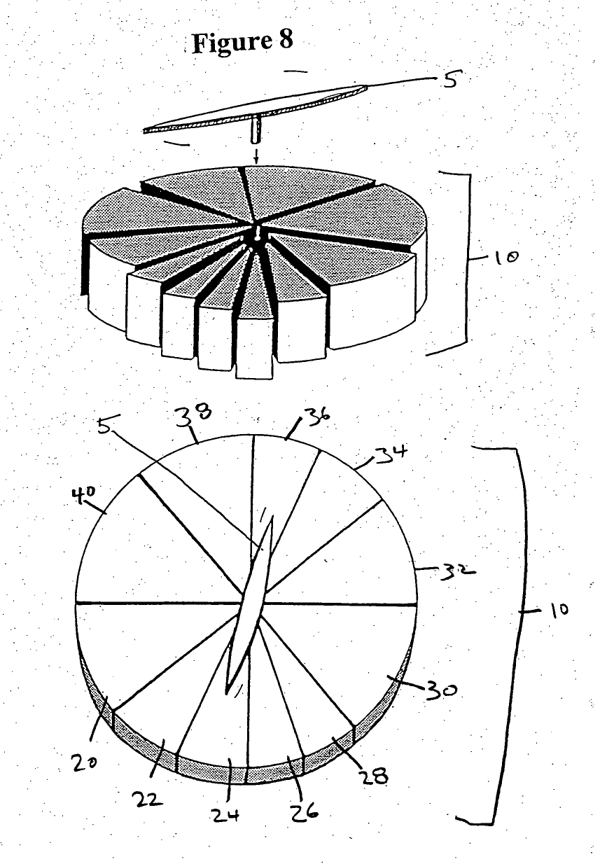

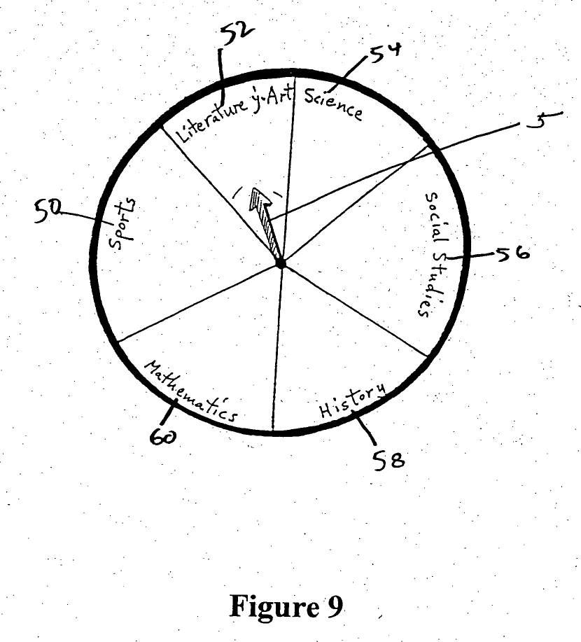

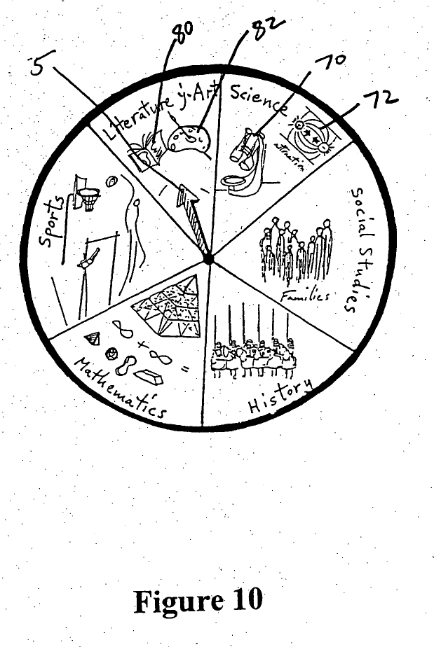

1. Referring now to FIG. 8, make a large wheel 10 (or functionally similar form), complete with spinner 5. The wheel should be at least three to four feet in diameter to allow room to add objects, images, and words.
2. Referring further to FIG. 8, divide the wheel 10 (or other appropriate shape) into approximately six to twelve segments 20, 22, 24, 26, 28, 30, 32, 34, 36, 38, 40. After making the segments, leave the wheel blank, with no words or images on it. Attach the wheel to a wall, or lay it on the floor or table, where everyone can see it.
3. Choose a broad subject, for example, education, environment, family, leisure, work, health, or sports. The subject must be of interest, or meaningful and familiar to the participants. For example, corporate life would not be a good subject for third grade children but would be for adults. However, a subject such as leisure activities would likely be interesting to any participant.
4. Referring now to FIG. 9, subdivide the subject into “categories” and place them as headings 50, 52, 54, 56, 58, 60 on each of the segments of the wheel. For education, the categories may be the different disciplines taught in secondary school, such as art, physics, chemistry, math, history, literature, etc. If the subject is leisure activities, participants could choose categories such as camping, music, sports, travel, etc. Again, make sure that the categories are meaningful to the participants.
5. Referring now to FIG. 10, list characteristics 70, 72, 80, 82 of each category. Participants should come up with words, phrases, images and icons that describe that category. For example, in the category of biology, participants could use words and images such as fish, mammals, microscopes and petri dishes. Participants should actually create these through writing, collage, drawing and other forms of symbol making, model building and construction. It is up to the participants to decide how many images, icons and other visual artifacts should be employed and which ones will best represent the categories. When finished, participants should attach their creations to the appropriate category on the wheel. For example, the category of biology would now have on it the symbols of fish, mammals, microscopes and petri dishes selected above. Larger images and three-dimensional forms and symbols may have to be attached outside the wheel with strings linking them to the appropriate category. Alternatively, if the creations are elaborate enough, they could be set around an entire room expanding the scope of the wheel. The wheel can become part of the surrounding environment physically encircling the participants.
6. Once the wheel is complete, the symbols, images and text on the wheel should be “unpacked,” or discussed and interpreted, in detail. This step will enable all participants to become familiar with the full realm of symbols used to create the wheel. It also will help participants understand the symbols in a deeper and more meaningful way.

The first stage of unpacking involves stepping back and observing the types of icons that were created as well as the similarities between icons. It may be helpful to make a list of all of the participants' responses. The list acts as a “memory log” of responses, so that participants can revisit and analyze a particular statement or figure of speech used to describe a symbol or convey an idea.

Initially, participants should address the physical characteristics and qualities of the wheel before addressing the conceptual elements and intentions. Are there a lot of colors used in the wheel? Is the wheel flat or very dimensional with much texture? Are the shapes, forms and media similar? Are the icons and symbols used representational, figurative or abstract?

After noting the physical similarities, participants should address the conceptual elements and intentions. They should describe the music or sounds the symbols and icons evoke. What would these works sound like, if they had a sound (e.g., classical, rock, jazz, rap, new age, tribal)? How would these works be different if they were the size of a room and participants could walk into or through them? How would these works be different if they were four-dimensional; i.e., had a time element to them, like moving kinetic sculptures?

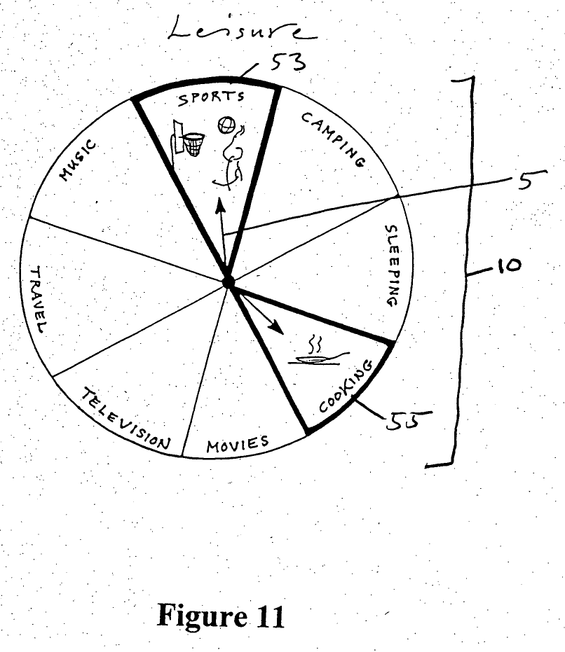

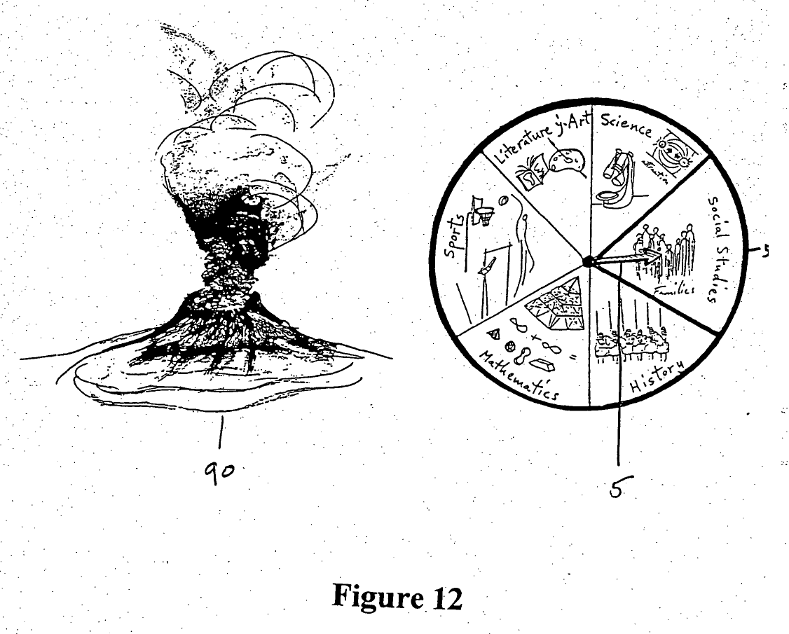

In the second stage of unpacking, participants should take turns interpreting their creations for the other participants. Participants should explain why they selected the symbols, colors, shapes, etc. that they did. They should also note what other creations are similar to their creations and why. Each aspect of the wheel should be explored in as great depth as possible, with all participants listening closely to the expressions of language and personal stories used in the descriptions.
7. Referring now to FIG. 11, to further explore and understand the wheel 10, spin the spinner 5 twice and note the two categories that the spinner lands on. The participants should then explore the connections between the two categories. It may be helpful to make a list of these connections. For example, if the subject is “leisure time” and the spinner lands on “cooking” and “sports”, the participants should list all the ways in which cooking and sports are similar. Are there ingredients in sports? Is there a chef? Do sports have anything comparable to a cookbook? Are there penalties in cooking? Is a kitchen like a playing field? All of these possibilities should be explored. The more connections, the better; nothing should be seen as too extreme or abstract.
8. Referring now to FIG. 12, choose an area of study for enhancement or an object that is of interest to the participants, something from which they wish to extract more meaning. For example, if it's a fifth grade teacher who wishes to enhance the students' knowledge about volcanoes and other eruptive structures in nature, then they should choose that. Once the area of study or object has been chosen, an icon is selected or created which represents it and placed next to the wheel. Here the teacher could place a picture or model of a volcano 90 next to the wheel.
9. Begin by spinning the spinner. Whatever category the spinner lands on should be related to the icon representing the area of study or object. In the volcano example, if the subject is “education” and the spinner lands on “social studies, 57” relate the volcano to social studies. That is, list all of the ways in which volcanoes are like social events. For example, a particular historical event may be taken, such as the 1991 Los Angeles Riot, or the break-up of the Eastern Bloc nations, and related to the turbulent birth and growth of a volcano.

Again, participants should begin with the obvious likenesses between these subjects—working from the general information and observation to the specific details. This will produce both general responses such as “war is like an erupting volcano,” to specific ones such as the “the Croats & Serbs are like the lava flow which hasn't yet cooled to form stable land masses (i.e., governments).” This is Step One (connection) of the process.

The teacher should encourage further discussion by introducing subject matter related to the volcano, such as how a volcano works, how seismic activity can be used to predict a volcanic eruption or how lava changes the landscape around it. All of these can be related back to social upheaval and war. How does the process of war resemble the process of a volcano? How do wars and volcanoes change the landscape around them? What are the conditions in which a volcano—or a war—occur? Can war be predicted or anticipated by studying the technological processes by which volcanic actions are forecasted? What can we learn from one about the other? More importantly, is it possible to stop a volcano and what are the implications of this for stopping war? Through this enhanced discussion, the students will soon be making discoveries concerning the nature of volcanoes, the nature of war and how war and volcanoes are similar in many ways. This is Step Two (discovery) of the process.
Step Three (invention) of the process involves building upon discoveries and inventing something based on them. For example, the students may discover that the same conditions which prevent a volcano from erupting, may be similar in process to those that prevent a war from occurring (e.g. a certain rock formation which blocks magma flow may resemble a blockade of arms). If the students use the knowledge that they gained to invent a way to cut down on playground fighting, they would be reaching Step Three (invention). If they actually applied this knowledge or used this knowledge to make further inventions, they would be at Step Four (application) of the process.
10. Repeat 9. Using the same icon as in number 9, spin the spinner again and relate the new selection to the icon. For example, if the spinner now lands on art, relate art—including, art forms, and techniques of art-making—to volcanoes.
   Note: if the participants ever get stuck on any given connection, spin again. The more they engage in this exercise, the less likely they will be to draw a blank.

The wheel can be used to move through all levels of the process quickly or slowly. During this process, the wheel enhances and enriches meaning in any subject or area of personal interest. A key to this process is starting with the participant's personal knowledge and life experiences and applying the new area of learning directly back to that base knowledge. The volcano example assumes that the students know something about social studies. If they didn't, the exercise wouldn't be nearly as fruitful.

Another key involves letting the participants create the wheel themselves, using their base of personal knowledge in the process. Through this method, the participants have ownership of the wheel. This ownership makes it very personal to them and gives them a real stake in shaping the process and product of education. Even the act of deciding what categories to pick-and-choose and what images to place on the wheel teaches invaluable lessons about how to select and make meaning from information. It also shows that information and categorization are not fixed, and that information can be presented and divided in almost infinite ways.

Another feature of the wheel is that it can be used over time. Participants can continually use it to enhance their knowledge about any subject that they would like to learn about. In the teacher/volcano example, the teacher could reuse the wheel to teach other course content. The wheel should be updated periodically—or completely reformulated—in order to reflect the growth of the participants who created it.

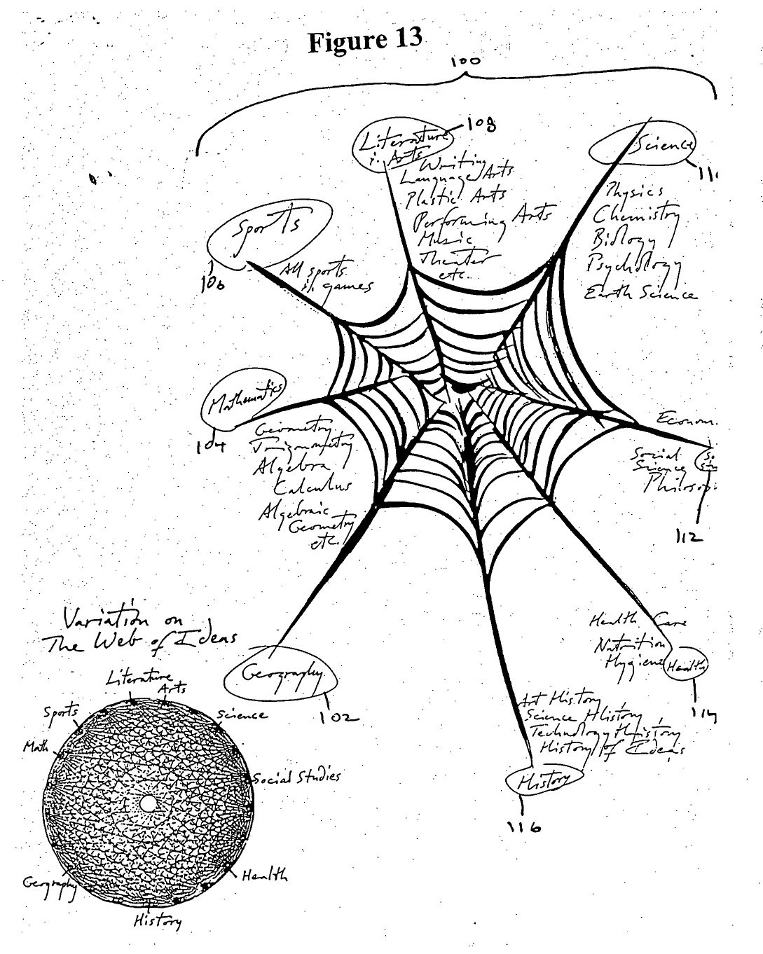

Referring now to FIG. 13, the steps of the process can be further modified for classroom use by having the participating students physically create their own wheel. One way to do this is to draw an idea web 100 on the blackboard. The students can brainstorm categories 102, 104, 106, 108, 110, 112, 114, 116 for the given subject and the teacher places these categories of ideas onto the web. The students could then distill the web into the best eight to twelve main categories, which should also be listed on the board.

Students would then have the opportunity to divide themselves into groups and create images, text and models for a category of their choice. A group of students could also be assigned to building the wheel itself. This latter assignment would involve the students having to design the wheel, select the materials and build it.

Prior to doing the wheel, the teacher should explain to the students that they will be designing and using their own learning system. The wheel will be used for seeing the relationships between things, connecting things and discovering the meaning of these connections. How they go about creating this learning system is up to them, from how it looks to what is on it.

It might also be helpful to show pictures of how humans have used wheels throughout history, such as early wheels with carts, Indian prayer wheels and even modern, metaphorical wheels as in the popular television game “The Wheel of Fortune.” Teachers may even create their own wheels and show these to the class. The discussion of all of these wheels will put what the students are doing in perspective while also demonstrating the versatility of wheels.

Participants may also invent games based on the wheel. This includes the creation of scoring systems and rules of play. Encourage the participants to be as creative as they can with the creation of the wheel. The wheel can take many forms and be simple and complicated in form or playing rules. Experiment with the wheel, noting how each different construction, tells a different story. Another feature of the wheel is that it can be used over a long period. Participants can continually use it to engage and enhance any new information, subject or problem that they would like to. The wheel should be updated periodically—or completely reformulated—in order to reflect the growth of the participants who created it.

While the exemplary preferred embodiment of the present invention is described herein with particularity, those having ordinary skill in the art will recognize various changes, modifications, additions, and applications other than those specifically described herein, and may adapt the preferred embodiment and methods without departing from the spirit of the invention.

1-4. (canceled)

5. A method for graphically representing information using one or more software routines that include an electronic toolbox and are capable of powering a displaying the electronic structure created using the software routines, said method comprising:
Selecting one or more items from an electronic toolbox provided in a software routine or program, wherein each item is selected to symbolize a topic or issue associated with a specific subject;
Identifying at least one connection from the electronic toolbox that represents a logical, intuitive or metamorphical connection between the selected items;
connecting one or more items with a connector until each selected item is connected to at least one other selected item;
displaying the electronic structure to at least one viewer;
recording any communications by the viewer in response to the viewing the electronic structure; and
storing one or more explanations of any symbolic representations reflected each item and connection included within the electronic structure.

6. The method of claim 5, further comprising the steps of:
providing a viewer with one or more electronically stored explanations and an electronic copy of the structure;
permitting the viewer to modify the electronic structure by selecting one or more additional items from the electronic toolbox that represent information about the subject as communicated by the viewer; and
responsive to the addition of an item to the structure, adding a connector that represents a connection between the additional item and the structure.

7. The method of claim 5, wherein the step of selecting items from an electronic toolbox includes selecting flat images such as photographs or drawings.

8. The method of claim 7, wherein the step of selecting items from an electronic toolbox includes selecting a 3-dimensional shape.

9. The method of claim 6, wherein the step of connecting one or more items includes connecting a flat image and a selected 3-dimensional shape such that the image becomes the surface of the selected shape.

10. The method of claim 5, wherein the step of storing explanations includes storing any symbolic analysis of the representations.

11. The method of claim 5, wherein the step of storing explanations includes storing any interpretations of the representations.

12. The method of claim 5, wherein the step of storing explanations includes storing any oral descriptions in one or more electronic files that can be associated with the electronic structure.

13. The method of claim 5, wherein the step of storing explanations includes storing any written descriptions in one or more electronic files that can be associated with the electronic structure.

14. The method of claim 5, wherein the step of storing explanations includes storing any non-verbal descriptions in one or more electronic video files that can be associated with the electronic structure.

15. The method of claim 5, wherein the step of storing explanations includes storing any explanations and the electronic structure being explained together on a network server.

16. The method of claim 15, further comprising the step of providing an index to any electronic structures that are stored on the network server.

17. The method of claim 16, wherein the step of providing an index includes providing a list of electronic structures by the subject of the electronic structures.

18. The method of claim 5, wherein the step of selecting items from an electronic toolbox includes selecting one or more electronic drawing tools that can be used to draw the item.

19. The method of claim 5, wherein the step of storing one or more explanations includes storing a description of the intended meaning of the items in the structure at the time it was being assembled.

20. The method of claim 5, wherein the step of assembling includes assembling structures having more than five dimensions.

21. The method of claim 5, wherein the step of assembling includes using art materials to assemble the structure such as pens, paints, photographs, and drawings.

22. The method of claim 5, wherein the step of connecting one or more items with a logical connection includes using hierarchical relations between the items.

23. The method of claim 6, wherein the viewer is more than one person.

24. The method of claim 23, further comprising the steps of viewed the electronic structure;
recording one more explanations of the electronic structure by other individuals that have
storing the explanations on an electronic media; and
logically linking the stored explanation with the electronic structure.

25. The method of claim 24, wherein the step of logically linking the stored explanation with the electronic structure includes the step of creating an electronic link, such as a hyperlink, to both the explanation and a stored copy of the electronic structure.

26. The method of claim 24, further comprising the step of permitting modification of the electronic structure by the viewer in order to apply the symbolic ideas represented by electronic structure to a different subject.

27. A software system for facilitating the creation of one or more symbolic structures, said comprising:
a processor for processing one or more software routines;
an electronic display connected to said processor for displaying output as requested by the software routines;
electronic memory connected to said processor for storing a collection of electronic media that can be used to represent information concerning a given subject; and
logically connected to said electronic memory and the processor, a software routine capable of providing:
an electronic toolbox;
an n-dimensional electronic palette for placing one or more items from the electronic toolbox into n-dimensional space; and
a dimensional routine, wherein such dimensional routine enables a user to view and edit any structures using the electronic toolbox by changing at least one-dimension of the n-dimensional palette.

28. The system of claim 26, wherein the software routine is capable of providing an electronic toolbox that includes links to one or more media items stored in electronic memory.

29. The system of claim 26, wherein the software routine is capable of providing an electronic toolbox that includes one or more objects that visually represent logical relations.

30. The system of claim 26, wherein the electronic memory is capable of storing one or more structures created on the electronic palette using the electronic toolbox.

31. The system of claim 26, wherein the electronic memory includes one or more electronic media that have been added by a user.

32. The system of claim 26, wherein the software routine includes a dimensional routine that can change the dimension of time.

33. The system of claim 26, wherein the software routine includes a dimensional routine that can change or more dimensions of three-dimensional space.

34. The system of claim 26, wherein the software routine further includes a software routine that is capable of putting one or more items of electronic media into motion within the electronic palette.

35. The system of claim 26, wherein the software routine further includes a software routine that is capable of making one or more items of electronic media flash within the electronic palette.
